(19) United States
(12) Patent Application Publication
(10) Pub. No.: US 2026/0196786 A1
(43) Pub. Date: Jul. 9, 2026

(54) SOCKET

(71) Applicant: POWERTECH INDUSTRIAL CO., LTD., NEW TAIPEI CITY (TW)

(72) Inventor: JUNG-HUI HSU, New Taipei City (TW)

(21) Appl. No.: 19/239,884

(22) Filed: Jun. 16, 2025

(30) Foreign Application Priority Data
Jan. 7, 2025 (TW) 114200213

(51) Int. Cl. H01R 27/00; H01R 13/11; H01R 13/512; H01R 13/627

(52) U.S. Cl. CPC H01R 27/00; H01R 13/113; H01R 13/512; H01R 13/6278

(57) ABSTRACT

A socket includes a body having a protruding portion, a lower-left portion connected to a part of the protruding portion that is located at a lower-left position of the protruding portion, and a lower-right portion connected to a part of the protruding portion that is located at a lower-right position of the protruding portion. Right and left cut-off corners are respectively formed at upper-right and upper-left corners of the body. A gap is formed between the lower-left and lower-right portions. A through hole is formed by the protruding portion and the gap. In a front view of the body, a width of the protruding portion is less than a straight-line distance between edges of the lower-left and lower-right portions. The lower-right and lower-left portions have lower-right and lower-left through holes, respectively. The body includes conductive members disposed in the through hole and the lower-right and lower-left through holes.

### CROSS-REFERENCE TO RELATED PATENT APPLICATION

This application claims the benefit of priority to Taiwan Patent Application No. 114200213, filed on Jan. 7, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a socket, and more particularly to a socket configured to accommodate various types of plugs.

### BACKGROUND OF THE DISCLOSURE

A conventional socket commonly used in cabinets (particularly in server cabinets) can only accommodate a single type of plug. In practice, since users may replace machines in the server cabinet due to various factors, the situation in which the socket available on the cabinet is not usable due to a specification mismatch may occur.

### SUMMARY OF THE DISCLOSURE

In response to the above-referenced technical inadequacy, the present disclosure provides a socket designed to improve user inconvenience caused by a conventional socket used in cabinets being configured to accommodate only a single type of plug.

In order to solve the above-mentioned problem, one of the technical aspects adopted by the present disclosure is to provide a socket. The socket includes a body having a protruding portion, a lower-left portion, and a lower-right portion. The lower-left portion is connected to a part of the protruding portion that is located at a lower-left position of the protruding portion, the lower-right portion is connected to a part of the protruding portion that is located at a lower-right position of the protruding portion, and a right cut-off corner and a left cut-off corner are respectively formed at an upper-right corner and an upper-left corner of the body. A gap is formed between the lower-left portion and the lower-right portion, and a through hole that penetrates the body is jointly formed by the protruding portion and the gap jointly. In a front view of the body, a width of the protruding portion is less than a straight-line distance between an edge of the lower-left portion and an edge of the lower-right portion. Two inclined surfaces are respectively formed at an upper-right position of the protruding portion and an upper-left position of the protruding portion. The lower-right portion has a lower-right through hole that penetrates the lower-right portion, the lower-right through hole includes a lower-right longitudinal through hole and a lower-right transverse through hole that are in spatial communication with each other, and an end of the lower-right longitudinal through hole is in spatial communication with the lower-right transverse through hole. The lower-left portion has a lower-left through hole that penetrates the lower-left portion, the lower-left through hole includes a lower-left longitudinal through hole and a lower-left transverse through hole that are in spatial communication with each other, and an end of the lower-left longitudinal through hole is in spatial communication with the lower-left transverse through hole. The body includes a plurality of conductive members that are respectively disposed in the through hole, the lower-right through hole, and the lower-left through hole.

Therefore, in the socket provided by the present disclosure, by virtue of “the body having the protruding portion, the lower-left portion, the lower-right portion, the right cut-off corner, the left cut-off corner, the gap, the through hole, the lower-right through hole, and the lower-left through hole,” the socket can interconnect with plugs having different specifications.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 to FIG. 3 are schematic views of a socket according to the present disclosure from different perspectives;

FIG. 4 is a schematic view of a cover, a seat, an elastic member, and a body of the socket in a separated state according to the present disclosure;

FIG. 5 is a schematic view of the socket without the cover and the seat according to the present disclosure;

FIG. 6 is a schematic view of a plurality of conductive members and the body of the socket in a separated state according to the present disclosure;

FIG. 7 is a schematic view of a pushing member, a latching member, and the body of the socket in a separated state according to the present disclosure;

FIG. 8 and FIG. 9 are schematic views of the body and a housing of the socket according to the present disclosure from different perspectives;

FIG. 10 is a schematic front view of the body and the housing of the socket according to the present disclosure;

FIG. 11 is a partly cross-sectional view of the socket when a pressing arm is not pressed according to the present disclosure; and

FIG. 12 is a partly cross-sectional view of the socket after the pressing arm is pressed according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

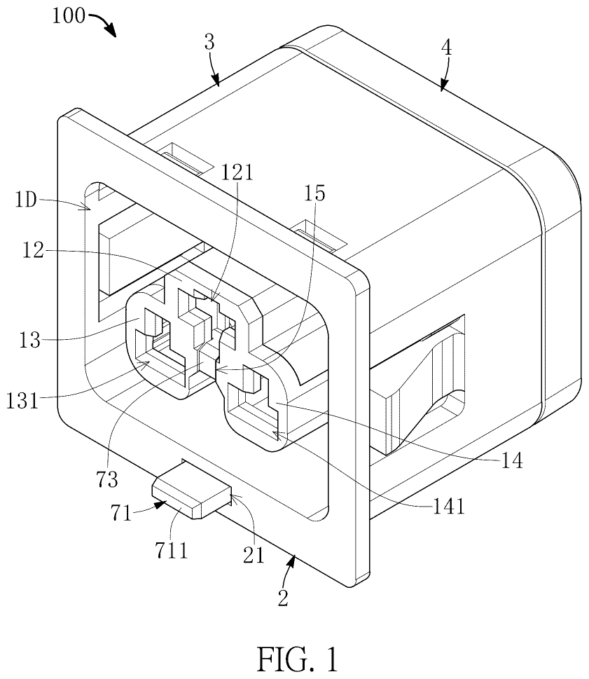

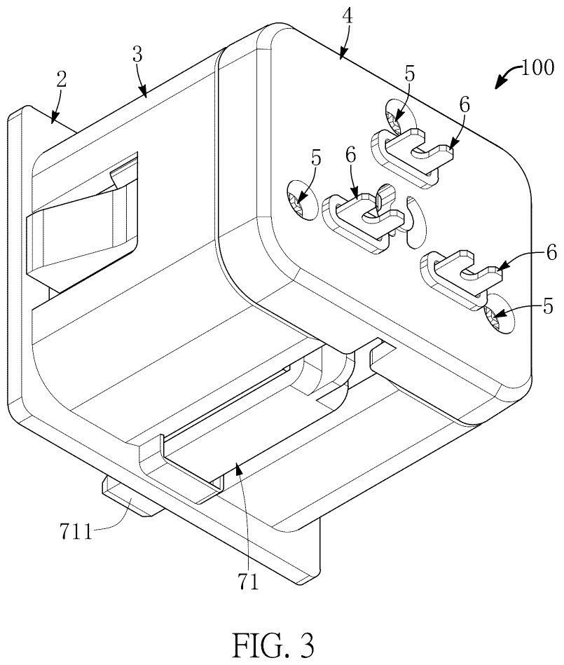

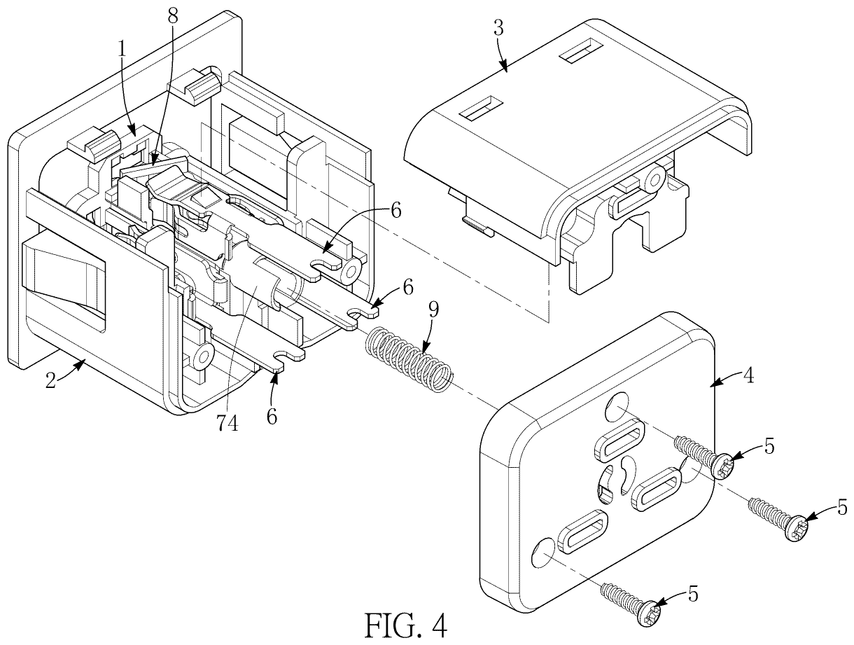

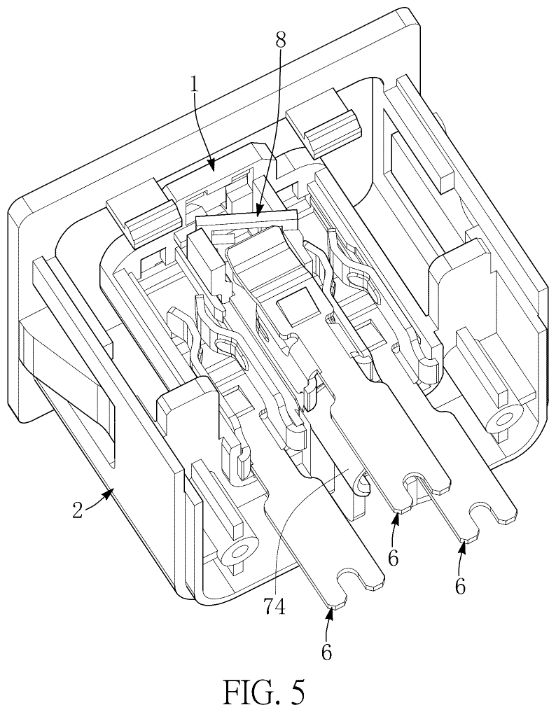

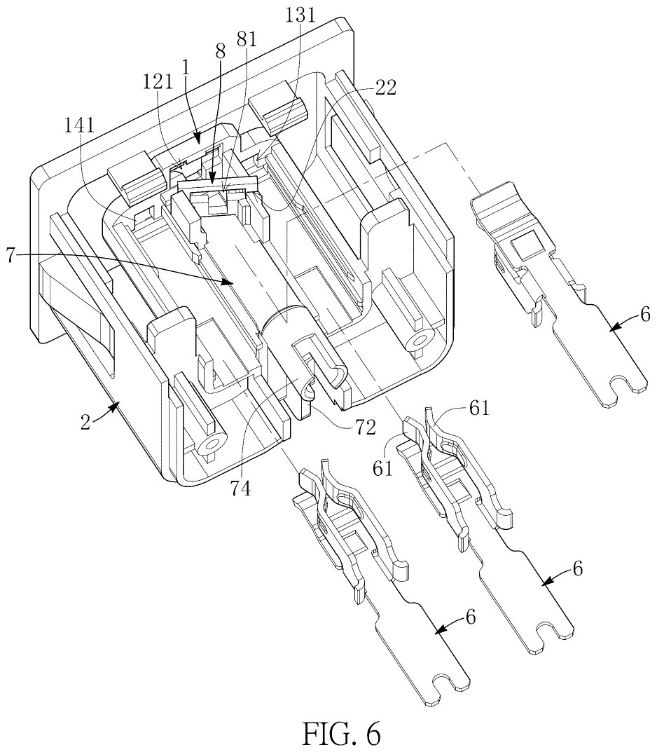

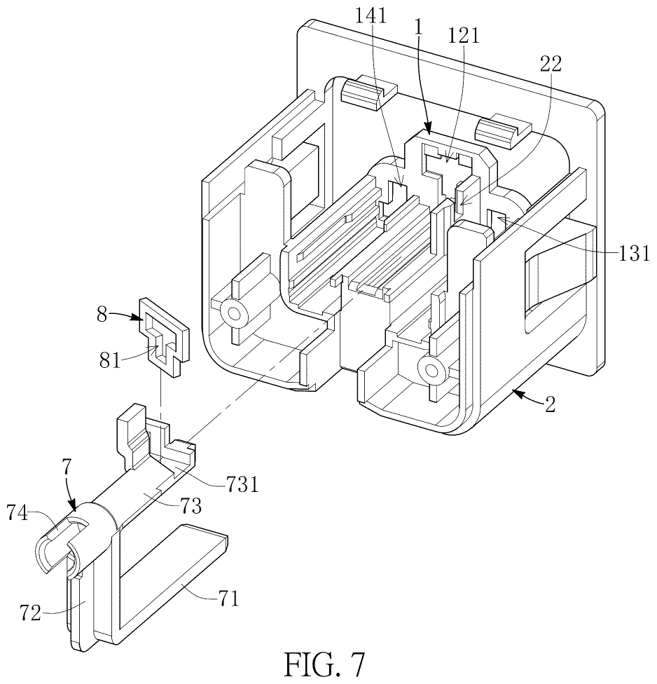

Referring to FIG. 1 to FIG. 7, FIG. 1 to FIG. 3 are schematic views of a socket according to the present disclosure from different perspectives, FIG. 4 is a schematic view of a cover, a seat, an elastic member, and a body of the socket in a separated state according to the present disclosure, FIG. 5 is a schematic view of the socket without the cover and the seat according to the present disclosure, FIG. 6 is a schematic view of a plurality of conductive members and the body of the socket in a separated state according to the present disclosure, and FIG. 7 is a schematic view of a pushing member, a latching member, and the body of the socket in a separated state according to the present disclosure.

A socket 100 of the present disclosure includes a body 1, a housing 2, a cover 3, a seat 4, a plurality of fastening members 5, three conductive members 6, a pushing member 7, a latching member 8, and an elastic member 9. In different embodiments, the socket 100 may also be configured without the pushing member 7, the latching member 8, and the elastic member 9.

The body 1 and the housing 2 may be an integrally formed structure, and an annular accommodating groove 1D is formed between the body 1 and the housing 2. A portion of the cover 3 is engaged with the housing 2, another portion of the cover 3 is connected to the body 1, and the cover 3 may be fixed to the seat 4 via the fastening members 5. The seat 4 is fixed to the housing 2 through the fastening members 5.

The conductive members 6 are engaged with the housing 2, and one end of each of the conductive members 6 is exposed from the seat 4. The three conductive members 6 can connect with a live conductor, a neutral conductor, and a protective earth of a plug that is inserted into the socket 100. Each of the conductive members 6 may, for example, include two elastic arms 61 (as shown in FIG. 6), and the two elastic arms 61 can hold a conductive member of the plug.

Referring to FIG. 6 and FIG. 7, the pushing member 7 is movably mounted on the housing 2. After the pushing member 7 and the latching member 8 are mounted on the housing 2, a portion of the latching member 8 may be engaged with a driving structure 731 of the pushing member 7, and another portion of the latching member 8 may be engaged with a limiting hole 22 of the housing 2. Two ends of the elastic member 9 are respectively fixed to the seat 4 and a retaining structure 74 of the pushing member 7.

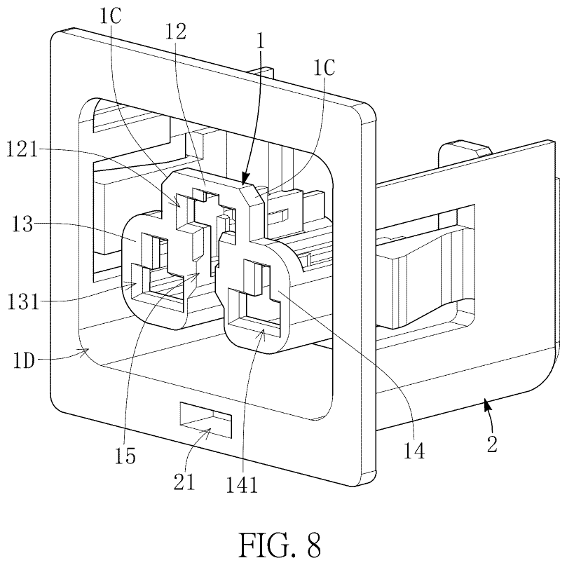

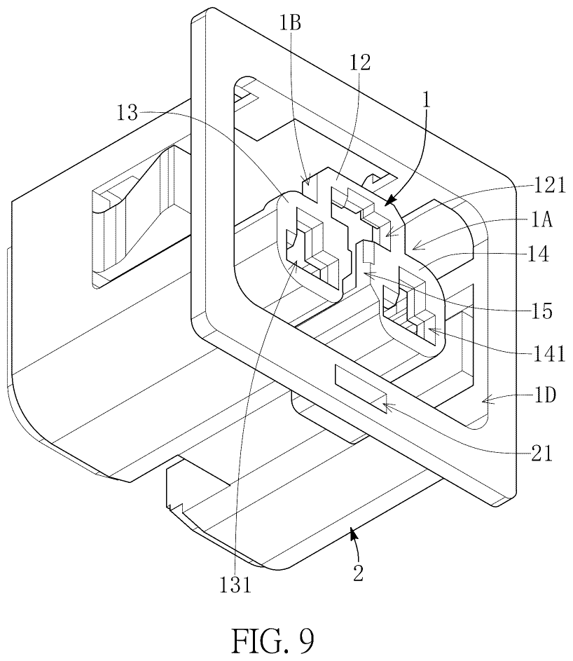

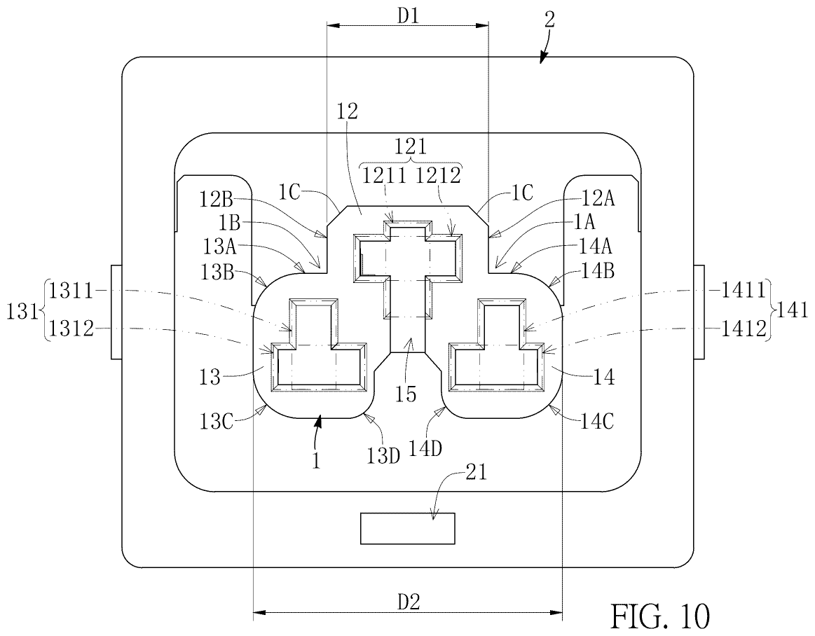

Referring to FIG. 8 to FIG. 10, FIG. 8 and FIG. 9 are schematic views of the body and a housing of the socket according to the present disclosure from different perspectives, and FIG. 10 is a schematic front view of the body and the housing of the socket according to the present disclosure. The body 1 has a protruding portion 12, a lower-left portion 13, and a lower-right portion 14. The lower-left portion 13 is connected to a part of the protruding portion 12 that is located at a lower-left position of the protruding portion 12, and the lower-right portion 14 is connected to a part of the protruding portion 12 that is located at a lower-right position of the protruding portion 12. A right cut-off corner 1A and a left cut-off corner 1B are respectively formed at an upper-right corner and an upper-left corner of the body 1. An upper-right corner and an upper-left corner of the protruding portion 12 each have an inclined surface 1C.

The protruding portion 12, the lower-left portion 13, and the lower-right portion 14 are integrally formed as a single structure. In a front view of the body 1 (as shown in FIG. 10), a width D1 of the protruding portion 12 is less than a straight-line distance D2 between an edge of the lower-left portion 13 and an edge of the lower-right portion 14. The protruding portion 12, the lower-left portion 13, and the lower-right portion 14 jointly and substantially present a convex-shaped structure.

A gap 15 is formed between the lower-left portion 13 and the lower-right portion 14. A connecting arm 72 of the pushing member 7 is located in the gap 15 (as shown in FIG. 1). The through hole 121 that penetrates the body 1 is jointly formed by the protruding portion 12 and the gap 15, and the through hole 121 includes a longitudinal through hole 1211 and a transverse through hole 1212. The longitudinal through hole 1211 is in spatial communication with the transverse through hole 1212. A width of the longitudinal through hole 1211 is the same as a width of the gap 15, and a part of the longitudinal through hole 1211 is formed by the gap 15. In the drawing of the present embodiment, the through hole 121 is exemplified to have a cross shape. However, the through hole 121 may have a cross shape, a T shape, or other shapes, and the present disclosure is not limited thereto.

Parts of the lower-right portion 14 that are located at an upper-right position, a lower-right position, and a lower-left position of the lower-right portion 14 are respectively arc-shaped structures 14B, 14C, and 14D. In one specific embodiment (as shown in FIG. 10), in the front view of the body 1, a minimum fillet radius of the arc-shaped structure 14C at the lower-right position of the lower-right portion 14 may be 3 millimeters, and a maximum fillet radius of the arc-shaped structure 14D at the lower-left position of the lower-right portion 14 may be 3 millimeters.

Parts of the lower-right portion 14 further include a lower-right through hole 141. The lower-right through hole 141 penetrates the lower-right portion 14 and includes a lower-right longitudinal through hole 1411 and a lower-right transverse through hole 1412 that are in spatial communication with each other. One end of the lower-right longitudinal through hole 1411 is in spatial communication with the lower-right transverse through hole 1412. As shown in FIG. 10, in the front view of the body 1, a longitudinal central axis of the lower-right longitudinal through hole 1411 and a longitudinal central axis of the lower-right transverse through hole 1412 are not positioned on the same axis, and the lower-right longitudinal through hole 1411 is disposed to be offset toward a right side of the lower-right transverse through hole 1412.

Parts of the lower-left portion 13 that are located at an upper-left position, a lower-left position, and a lower-right position of the lower-left portion 13 are respectively arc-shaped structures 13B, 13C, and 13D. As shown in FIG. 10, in one specific embodiment, in the front view of the body 1, a minimum fillet radius of the arc-shaped structure 13C at the lower-left position of the lower-left portion 13 may be 3 millimeters, and a maximum fillet radius of the arc-shaped structure 13D at the lower-right position of the lower-left portion 13 may be 3 millimeters.

The lower-left portion 13 has a lower-left through hole 131 that penetrates the lower-left portion 13, and the lower-left through hole 131 includes a lower-left longitudinal through hole 1311 and a lower-left transverse through hole 1312 that are in spatial communication with each other. One end of the lower-left longitudinal through hole 1311 is in spatial communication with the lower-left transverse through hole 1312.

As shown in FIG. 10, in the front view of the body 1, a longitudinal central axis of the lower-left longitudinal through hole 1311 and a longitudinal central axis of the lower-left transverse through hole 1312 are not aligned on the same axis. A position of the lower-left longitudinal through hole 1311 is offset toward a left side of the lower-left transverse through hole 1312.

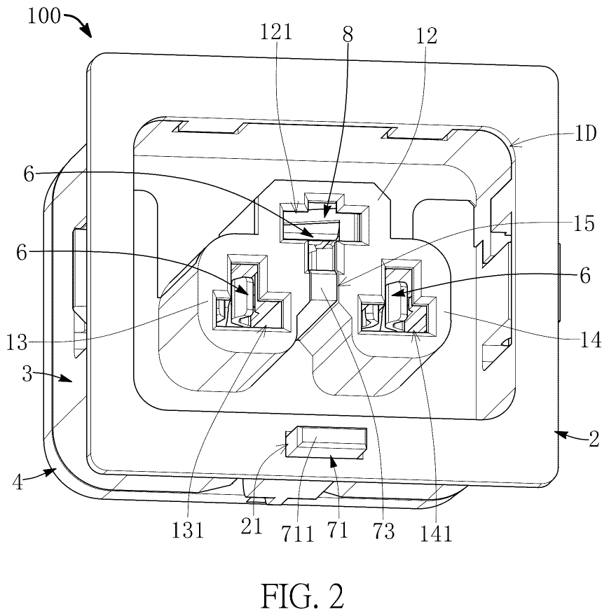

Referring to FIG. 2, the body 1 includes a plurality of conductive member 6 respectively disposed in the through hole 121, the lower-right through hole 141, and the lower-left through hole 131. When the plug is inserted into the socket 100, three conductive members of the plug respectively pass through the through hole 121, the lower-right through hole 141, and the lower-left through hole 131, so as to be held by the three corresponding conductive members 6.

As described above, in the socket 100 provided by the present disclosure, by virtue of “the body 1 having the protruding portion 12, the lower-left portion 13, the lower-right portion 14, the right cut-off corner 1A, the left cut-off corner 1B, the gap 15, the through hole 121, the lower-right through hole 141, and the lower-left through hole 131,” the socket can interconnect with plugs having different specifications. Specifically, the socket 100 of the present disclosure complies with IEC standards, and is capable of meeting connection requirements for C14, C16, C20, and C22 socket specifications.

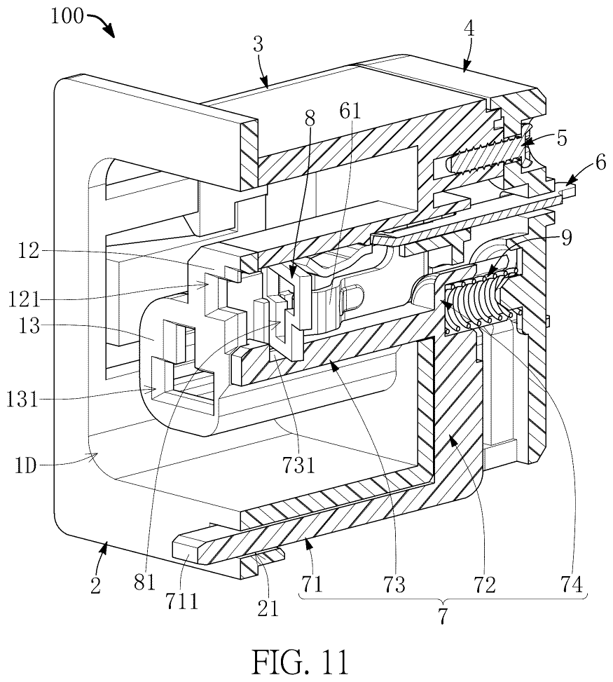

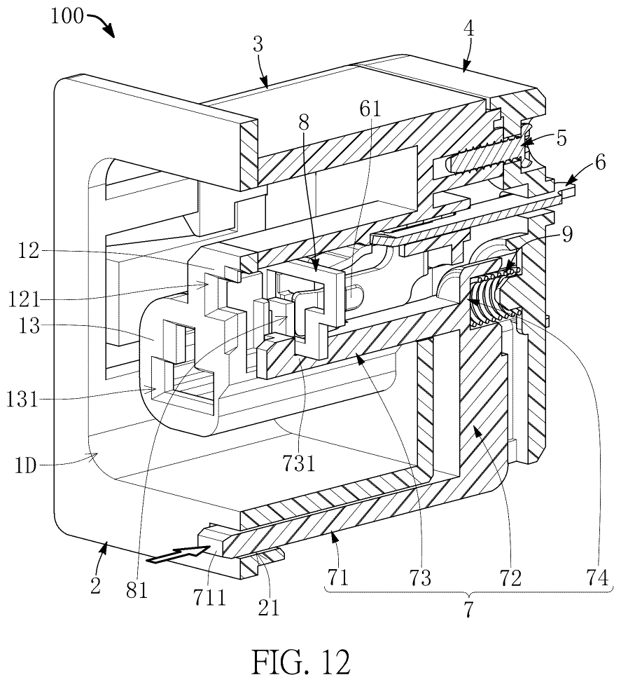

Reference is made to FIG. 6, FIG. 7, FIG. 11, and FIG. 12. FIG. 11 is a partly cross-sectional view of the socket when a pressing arm is not pressed according to the present disclosure, and FIG. 12 is a partly cross-sectional view of the socket after the pressing arm is pressed according to the present disclosure.

The pushing member 7 may include a pressing arm 71, a connecting arm 72, and a driving arm 73. Two ends of the connecting arm 72 are respectively connected to the pressing arm 71 and the driving arm 73, and the pressing arm 71 and the driving arm 73 are disposed facing each other. An overall structure of the pushing member 7 is substantially similar to a U-shaped configuration.

The pushing member 7 may further include a retaining structure 74. One end of the elastic member 9 is fixed to the retaining structure 74. A driving structure 731 is disposed at an end of the driving arm 73 that is not connected to the connecting arm 72. The latching member 8 is connected to the driving structure 731. The latching member 8 may be similar to a hollow T-shaped structure, and has a T-shaped through hole 81. Two ends of the elastic member 9 are respectively fixed to the retaining structure 74 and the seat 4. An exposed end 711 of the pressing arm 71 passes through a through hole 21 of the housing 2, and is exposed from the housing 2. Moreover, the pressing arm 71 further has a light-guiding function to serve as a power indicator or a display of the usage status.

Referring to FIG. 11, in a state where the exposed end 711 is not pressed, the elastic member 9 may be slightly compressed by the pushing member 7. The pushing member 7 is maintained in the state shown in FIG. 11 due to an elastic restoring force generated by compression of the elastic member 9. That is, the exposed end 711 remains to be in a state of being exposed from the housing 2. The latching member 8 in the state shown in FIG. 11 is positioned at a latching position, and is in an inclined state due to being constrained by the pushing member 7 and a limiting hole 22 of the housing 2. That is, a central axis of the latching member 8 is not parallel to a central axis of the through hole 121.

Referring to FIG. 12, when the exposed end 711 is pressed, the pressing arm 71, the connecting arm 72, and the driving arm 73 move closer to the seat 4, and the pushing member 7 compresses the elastic member 9, so that the latching member 8 rotates in a direction toward the seat 4 along with the driving arm 73. Accordingly, the latching member 8 moves from the latching position (as shown in FIG. 11) to an unlocking position (as shown in FIG. 12). At this time, the central axis of the latching member 8 and the central axis of the through hole 121 are substantially parallel to or overlapped with each other.

In a scenario shown in FIG. 12, when the exposed end 711 is no longer pressed, an elastic restoring force generated by the compressed elastic member 9 will restore the pushing member 7 to an unpressed state. Simultaneously, the pushing member 7 will drive the latching member 8 to move from the unlocking position (as shown in FIG. 12) to the engaging position (as shown in FIG. 11).

In one embodiment, by virtue of the gap between the latching member 8, the through hole 121, and the two elastic arms 61 of the conductive member 6, the positional relationship of these components enables the conductive member of the plug to directly push against the latching member 8 after passing through the through hole 121, thereby temporarily switching the latching member 8 from the latching position shown in FIG. 11 to the unlocking position shown in FIG. 12. Accordingly, the conductive member of the plug can directly enter the gap between the two elastic arms 61. After the conductive member of the plug enters the gap between the two elastic arms 61, the latching member 8 returns to the latching position to engage with the conductive member of the plug, so that the conductive member of the plug cannot be directly pulled out from the socket 100.

In other words, when the socket 100 of the present disclosure is used by the user, the user can directly insert the plug into the socket 100 without pressing the exposed end 711. When the user intends to remove the plug, it is necessary for the user to press the exposed end 711 for moving the latching member 8 to the unlocking position, so that the plug can be smoothly removed from the socket 100. Such configuration can significantly enhance user convenience.

In conclusion, in the socket provided by the present disclosure, by virtue of “the body having the protruding portion, the lower-left portion, the lower-right portion, the right cut-off corner, the left cut-off corner, the gap, the through hole, the lower-right through hole, and the lower-left through hole,” the socket can interconnect with plugs having different specifications. Furthermore, the socket of the present disclosure is suitable for being installed in various types of cabinets, particularly in server cabinets.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A socket, comprising:
a body having a protruding portion, a lower-left portion, and a lower-right portion, wherein the lower-left portion is connected to a part of the protruding portion that is located at a lower-left position of the protruding portion, the lower-right portion is connected to a part of the protruding portion that is located at a lower-right position of the protruding portion, and a right cut-off corner and a left cut-off corner are respectively formed at an upper-right corner and an upper-left corner of the body; wherein a gap is formed between the lower-left portion and the lower-right portion, and a through hole that penetrates the body is jointly formed by the protruding portion and the gap; wherein, in a front view of the body, a width of the protruding portion is less than a straight-line distance between an edge of the lower-left portion and an edge of the lower-right portion; wherein two inclined surfaces are respectively formed at an upper-right position of the protruding portion and an upper-left position of the protruding portion; wherein the lower-right portion has a lower-right through hole that penetrates the lower-right portion, the lower-right through hole includes a lower-right longitudinal through hole and a lower-right transverse through hole that are in spatial communication with each other, and an end of the lower-right longitudinal through hole is in spatial communication with the lower-right transverse through hole; wherein the lower-left portion has a lower-left through hole that penetrates the lower-left portion, the lower-left through hole includes a lower-left longitudinal through hole and a lower-left transverse through hole that are in spatial communication with each other, and an end of the lower-left longitudinal through hole is in spatial communication with the lower-left transverse through hole; wherein the body includes a plurality of conductive members that are respectively disposed in the through hole, the lower-right through hole, and the lower-left through hole.

2. The socket according to claim 1, wherein a part of the lower-right portion that is located at an upper-right position of the lower-right portion is an arc-shaped structure, and a part of the lower-left portion that is located at an upper-left position of the lower-left portion is an arc-shaped structure.

3. The socket according to claim 2, wherein a part of the lower-right portion that is located at a lower-right position of the lower-right portion and a part of the lower-right portion that is located at a lower-left position of the lower-right portion are arc-shaped structures; wherein a part of the lower-left portion that is located at a lower-left position of the lower-left portion and a part of the lower-left portion that is located at a lower-right position of the lower-left portion are arc-shaped structures.

4. The socket according to claim 1, wherein, in the front view of the body, a longitudinal central axis of the lower-right longitudinal through hole and a longitudinal central axis of the lower-right transverse through hole are not aligned on a same axis; wherein a position of the lower-right longitudinal through hole is offset toward a right side of the lower-right transverse through hole.

5. The socket according to claim 1, wherein, in the front view of the body, a longitudinal central axis of the lower-left longitudinal through hole and a longitudinal central axis of the lower-left transverse through hole are not aligned on a same axis; wherein a position of the lower-left longitudinal through hole is offset toward a left side of the lower-left transverse through hole.

6. The socket according to claim 1, wherein the through hole includes a longitudinal through hole and a transverse through hole that is in spatial communication with the transverse through hole, and a width of the longitudinal through hole is the same as a width of the gap.

7. The socket according to claim 1, further comprising a housing connected to the body; wherein an annular accommodating groove is formed between the housing and the body.

8. The socket according to claim 7, further comprising a seat, an elastic member, a pushing member, and a latching member; wherein the body is connected to the seat, one of two ends of the elastic member is fixed to the seat, and another one of the two ends of the elastic member is fixed to the pushing member; wherein a part of the pushing member is configured to be pressable for driving the latching member to move from a latching position to an unlocking position; wherein, when the pushing member is pressed, the pushing member compresses the elastic member; wherein, when the pushing member is not pressed, an elastic restoring force generated by the elastic member returns the pushing member to an unpressed position of the pushing member, and the pushing member drives the latching member to return to the latching position; wherein, when the latching member is located at the latching position, the latching member is configured to engage with a conductive member of a plug that is inserted into the socket.

9. The socket according to claim 8, wherein the pushing member includes a pressing arm, a connecting arm, and a driving arm, two ends of the connecting arm are respectively connected to the pressing arm and the driving arm, and the pressing arm and the driving arm are disposed facing each other; wherein an exposed end of the pressing arm passes through a through hole of the housing, and is exposed from the housing; wherein, when the exposed end is pressed, the driving arm is driven and moves in a direction away from the through hole.

10. The socket according to claim 8, wherein the pressing arm further has a light-guiding function.

11. The socket according to claim 8, wherein the driving arm is located in the gap.
